(19) United States
(12) Patent Application Publication
(10) Pub. No.: US 2025/0151719 A1
(43) Pub. Date: May 15, 2025

(54) MICROENCAPSULATED ESSENTIAL OILS

(71) Applicant: NANOMIK BIYOTEKNOLOJI ANONIM SIRKETI, Istanbul (TR)

(72) Inventors: Arda ORCEN, Istanbul (TR); Buse BERBER ORCEN, Istanbul (TR)

(21) Appl. No.: 18/726,901

(22) PCT Filed: Jan. 6, 2023
(86) PCT No.: PCT/TR2023/050014

§ 371 Date: Jul. 5, 2024

(30) Foreign Application Priority Data
Jan. 6, 2022 (TR) 2022/000165

(51) Int. Cl. A01N 25/28; A01N 65/08; A01N 65/22; A01N 65/24; A01N 65/28; A01N 65/34; A01N 65/36; A01P 1/00; A01P 3/00

(52) U.S. Cl. CPC A01N 25/28; A01N 65/08; A01N 65/22; A01N 65/24; A01N 65/28; A01N 65/34; A01N 65/36; A01P 1/00; A01P 3/00

(57) ABSTRACT

The invention relates to an antimicrobial microcapsule formulation comprising one or more essential oils and/or essential oil active ingredients and including chitosan in its wall structure.

### TECHNICAL FIELD

The present invention relates to microcapsule compositions comprising one or more essential oils or essential oil active ingredients and including chitosan in their wall structure, and to the use of said compositions in the food, agriculture and cosmetics industries in order to improve the product quality, increase the shelf life of the products, and protect the products against microorganisms.

### BACKGROUND ART

According to the knowledge obtained from literature and field studies, in agriculture, food and cosmetics industries, chemical products are often used to protect the respective products against microorganisms.

In particular, chemical pesticides are used in plant protection and pest control. Chemical pesticides are synthetically prepared products which are used to prevent agricultural pests. Most of such pesticides act by exhibiting toxic effects on target organisms, and the mechanisms of action of this kind of pesticides usually take place through a single pathway. It is precisely for this reason that the presence of these pesticides results in toxic effects not only for target organisms but also for non-target organisms. In the short term, chemical pesticides can have a variety of effects on mammals, such as contact poisoning, acute nausea, skin irritation, and/or burning, and in the long term, they can cause health and environmental problems as a result of the accumulation of these substances in nature. Another problem with the long-term use of chemical pesticides, which presents itself because the chemical pesticides act through a single pathway as noted above, is that pathogenic microorganisms develop resistance to these pesticides over time, leading to a decrease in the efficacy of the chemical pesticides, which in turn results in the need to use such chemical pesticides at a higher dose. The use of high doses of chemical pesticides not only causes more harm to living organisms and nature, but also prevents the products obtained in such way from being in compliance with the respective standards for consumption, leading to a food waste and a decreased product quality.

In food products, similarly, food additives, or food contact disinfectants are used to provide protection against microorganisms, and in general, said agents are also chemical in nature. Since the food contact disinfectants are typically volatile, they pose a health hazard, and require a constant re-preparation which is time-consuming for professional kitchens.

In recent years, biopesticides have been developed as an alternative to chemical disinfectants for protecting food products against microorganisms, as well as to chemical pesticides. Biopesticides may contain microorganism-based active ingredients, and/or organic compounds of plant origin, and/or organic compounds of microbial origin. In general, however, studies show that biopesticide products are not as effective as chemical pesticides. It is believed that the main reasons why biopesticides are not as effective as desired include the unstable nature of the plant-derived active ingredients, low doses of application, their short shelf life, and a decrease in their effects which occurs as a result of a degradation of their structure in the presence of heat-light-oxygen.

CN103548995 discloses the preparation of microcapsules of litsea cubeba oil, and their antibacterial and insect repellent effects.

CN108552228 discloses a formulation for use in the rice plant, wherein said formulation is prepared with plant-derived insecticides such as azadirachtin, a number of known chemical antifungal agents such as validamycin, and various essential oils.

Considering the state of the art, there is a need for stable formulations that are environmentally friendly and act as chemical pesticides, bactericides, fungicides, acaricides, and virucides.

As a result of their studies, the inventors have developed a chitosan microcapsule composition comprising one or more essential oil active ingredients, which would play an active role in solving this problem.

### SUMMARY OF THE INVENTION

The present invention relates to microcapsules formed by encapsulating one or more essential oil active ingredients with chitosan as a carrier, and to a method for producing such microcapsules.

In an embodiment of the invention, the encapsulated essential oil active ingredient is thymol.

In a preferred embodiment of the invention, the microcapsules comprise at least one other essential oil active ingredient in addition to thymol.

The composition comprising the microcapsules according to the invention has been found to be highly effective in agriculture when used as a bactericidal, fungicidal, acaricidal, or virucidal agent prior to harvesting, and as a preservative agent to increase the shelf life of fruits and vegetables. In addition, another benefit of the present invention is its use after harvesting to destroy microorganisms found in fruits and vegetables and carried from the agricultural field.

### DESCRIPTION OF THE FIGURES

FIG. 1: shows a DLS measurement graph for Formulation 1.

FIG. 2: shows a Zeta potential measurement graph for Formulation 1.

FIG. 3: shows a release kinetics graph for Formulation 1, wherein it is observed that the capsules can release up to 30 days and release at a lower rate under neutral conditions compared to that in an acidic medium.

FIG. 4: shows the minimum inhibitory concentrations of formulations and active ingredients against Aspergillus niger. (Abbreviations used for formulations: F1: Formulation 1; F2: Formulation 2; F3: Formulation 3; F4: Formulation 4; F5: Formulation 5; F6: Formulation 6; F7: Formulation 7; F8: Formulation 8; F9: Formulation 9; F10: Formulation 10. Abbreviations used for active ingredients: R1: Thymol; R2: Carvacrol; R3: Eugenol; R4: Geraniol; R5: Cinnamaldehyde).

FIG. 5: shows the minimum inhibitory concentrations of formulations and active ingredients against Penicillium digitatum. (Abbreviations used for formulations: F1: Formulation 1; F2: Formulation 2; F3: Formulation 3; F4: Formulation 4; F5: Formulation 5; F6: Formulation 6; F7: Formulation 7; F8: Formulation 8; F9: Formulation 9; F10: Formulation 10. Abbreviations used for active ingredients: R1: Thymol; R2: Carvacrol; R3: Eugenol; R4: Geraniol; R5: Cinnamaldehyde).

FIG. 6: shows the minimum inhibitory concentrations of formulations and active ingredients against Botrytis cinerea. (Abbreviations used for formulations: F1: Formulation 1; F2: Formulation 2; F3: Formulation 3; F4: Formulation 4; F5: Formulation 5; F6: Formulation 6; F7: Formulation 7; F8: Formulation 8; F9: Formulation 9; F10: Formulation 10. Abbreviations used for active ingredients: R1: Thymol; R2: Carvacrol; R3: Eugenol; R4: Geraniol; R5: Cinnamaldehyde).

FIG. 7: shows the minimum inhibitory concentrations of formulations and active ingredients against Xanthomonas juglandis. (Abbreviations used for formulations: F1: Formulation 1; F2: Formulation 2; F3: Formulation 3; F4: Formulation 4; F5: Formulation 5; F6: Formulation 6; F7: Formulation 7; F8: Formulation 8; F9: Formulation 9; F10: Formulation 10. Abbreviations used for active ingredients: R1: Thymol; R2: Carvacrol; R3: Eugenol; R4: Geraniol; R5: Cinnamaldehyde).

FIG. 8: shows the minimum inhibitory concentrations of formulations and active ingredients against Xanthomonas phaseoli. (Abbreviations used for formulations: F1: Formulation 1; F2: Formulation 2; F3: Formulation 3; F4: Formulation 4; F5: Formulation 5; F6: Formulation 6; F7: Formulation 7; F8: Formulation 8; F9: Formulation 9; F10: Formulation 10. Abbreviations used for active ingredients: R1: Thymol; R2: Carvacrol; R3: Eugenol; R4: Geraniol; R5: Cinnamaldehyde).

FIG. 9: shows the minimum inhibitory concentrations of formulations and active ingredients against Clavibacter michiganensis. (Abbreviations used for formulations: F1: Formulation 1; F2: Formulation 2; F3: Formulation 3; F4: Formulation 4; F5: Formulation 5; F6: Formulation 6; F7: Formulation 7; F8: Formulation 8; F9: Formulation 9; F10: Formulation 10. Abbreviations used for active ingredients: R1: Thymol; R2: Carvacrol; R3: Eugenol; R4:Geraniol; R5: Cinnamaldehyde).

FIG. 10: shows the minimum inhibitory concentrations of formulations and active ingredients against Fusarium culmorum. (Abbreviations used for formulations: F1: Formulation 1; F2: Formulation 2; F3: Formulation 3; F4: Formulation 4; F5: Formulation 5; F6: Formulation 6; F7: Formulation 7; F8: Formulation 8; F9: Formulation 9; F10: Formulation 10. Abbreviations used for active ingredients: R1: Thymol; R2: Carvacrol; R3: Eugenol; R4: Geraniol; R5: Cinnamaldehyde).

FIG. 11: shows the minimum inhibitory concentrations of formulations and active ingredients against Rhizoctonia solani. (Abbreviations used for formulations: F1: Formulation 1; F2: Formulation 2; F3: Formulation 3; F4: Formulation 4; F5: Formulation 5; F6: Formulation 6; F7: Formulation 7; F8: Formulation 8; F9: Formulation 9; F10: Formulation 10. Abbreviations used for active ingredients: R1: Thymol; R2: Carvacrol; R3: Eugenol; R4: Geraniol; R5: Cinnamaldehyde).

FIG. 12: shows the minimum inhibitory concentrations of formulations and active ingredients against Sclerotinia sclerotiorium. (Abbreviations used for formulations: F1: Formulation 1; F2: Formulation 2; F3: Formulation 3; F4: Formulation 4; F5: Formulation 5; F6: Formulation 6; F7: Formulation 7; F8: Formulation 8; F9: Formulation 9; F10: Formulation 10. Abbreviations used for active ingredients: R1: Thymol; R2: Carvacrol; R3: Eugenol; R4: Geraniol; R5: Cinnamaldehyde).

FIG. 13: shows the minimum inhibitory concentrations of formulations and active ingredients against Ascohyta rabiei. (Abbreviations used for formulations: F1: Formulation 1; F2: Formulation 2; F3: Formulation 3; F4: Formulation 4; F5: Formulation 5; F6: Formulation 6; F7: Formulation 7; F8: Formulation 8; F9: Formulation 9; F10: Formulation 10. Abbreviations used for active ingredients: R1: Thymol; R2: Carvacrol; R3: Eugenol; R4: Geraniol; R5: Cinnamaldehyde).

FIG. 14: shows the killing kinetics of Formulation 1 at a concentration of 1500 ppm against different microorganisms.

FIG. 15: shows the killing kinetics of Formulation 1 at a concentration of 1500 ppm against Penicillium Digitatum.

FIG. 16: shows the killing kinetics of Formulation 1 at a concentration of 300 ppm, and of chlorine, against Listeria monocytogenes.

FIG. 17: is a table showing the release of microcapsules at different pHs.

FIG. 18: shows a comparison made between Formulation 1 and Timorex Gold with respect to their performances against different Botyris cinera isolates. The graph shows mycelium growth rate by percentage.

FIG. 19: shows the results of a field experiment for the efficacy of Formulation 1 against powdery mildew (Erysiphae necator).

FIG. 20: shows the results obtained from an experiment carried out to test Formulation 1 in combination with synthetic fungicides in the fight against Powdery Mildew (Erysiphae necator).
20-A: Control
20-B: Prosper, Luna Experience, BayFidan, Flint
20-C: Formulation 1, Prosper, Luna Experience
20-D: Sercadis, Retreap
20-E: Formulation 1

FIG. 21: shows the results obtained from the tests carried out to test the biological efficacy of Formulation 1 against Botrytis Vine Rot (Botrytis cinerea).

FIG. 22: shows the results obtained from the tests carried out to test the biological efficacy of Formulation 1 in combination with spread-adhesive products against Botrytis Vine Rot (Botrytis cinerea).

### DETAILED DESCRIPTION OF THE INVENTION

As described above, the present invention relates to microcapsules comprising at least one essential oil and/or essential oil active ingredient, wherein the microcapsules have a wall structure consisting essentially of chitosan.

An embodiment of the invention relates to oil-water emulsion formulations comprising at least one essential oil or essential oil active ingredient, and having a wall structure selected from the group consisting of chitosan, alginate, gelatin, dextran, carboxymethyl cellulose, hydroxypropyl cellulose, xanthan gum, Arabic gum, starch, pectin, whey protein, soy protein and its combination thereof.

In a preferred embodiment of the invention, said essential oil active ingredient is selected from the group consisting of carvacrol, geraniol, cinnamaldehyde, eugenol, linalool, limonene, cuminaldehyde, L-carvone, citral, thymoquinone and its combination thereof, and said essential oil active ingredient is preferably thymol, carvacrol, cinnamaldehyde, eugenol or its combination thereof and most preferably thymol carvacrol or its combination thereof.

In a preferred embodiment of the invention, the microcapsules carry an oregano oil containing 80-95 vol % of thymol and carvacrol as an essential oil.

In one embodiment of the invention, the microcapsule or the oil-water emulsion formulation may comprise other essential oil active ingredient and said other essential oil active ingredient is carvacrol, geraniol, cinnamaldehyde, eugenol, linalool, limonene, cuminaldehyde, L-carvone, citral, or thymoquinone.

In another embodiment of the invention, the microcapsule or the oil-water emulsion formulation may comprise other essential oil and said other essential oil is oregano oil, clove oil, basil oil, lavender oil, lemon oil, orange oil, grapefruit oil, bergamot oil, cumin oil, rose oil, cinnamon oil, or mint oil.

The microcapsules or the oil-water emulsion formulation according to the invention may also contain combinations of these oils or oil active ingredients.

A preferred embodiment of the invention relates to formulations comprising thymol, eugenol, and carvacrol as an active ingredient, and at least one polymer-based carrier phase. The polymer-based carrier phase described herein is preferably chitosan.

Accordingly, another preferred embodiment of the invention relates to formulations comprising thymol, eugenol, and geraniol as an active ingredient, and at least one polymer-based carrier phase as an excipient.

Accordingly, another preferred embodiment of the invention relates to formulations comprising thymol, eugenol, carvacrol, and cinnamaldehyde as an active ingredient, and at least one polymer-based carrier phase as an excipient.

In a preferred embodiment of the invention, the thymol and the other essential oil active ingredient is in the range of 10-50 vol %.

The expression “polymer-based carrier phase” in the context of the invention refers to polymeric structures used in the preparation of formulations according to the invention.

In a preferred embodiment of the invention, the polymer-based carrier phase is selected from the group consisting of chitosan, alginate, gelatin, dextran, carboxymethyl cellulose, hydroxypropyl cellulose, xanthan gum, Arabic gum, starch, pectin, whey protein, soy protein. In a particularly preferred embodiment of the invention, chitosan is used as the polymer-based carrier phase.

In a preferred embodiment of the invention, the polymer-based phase, preferably chitosan, is used in the range of 40-85 vol % in the formulations according to the invention.

The formulations according to the invention may comprise at least one other excipient in addition to the active ingredient and at least one polymer-based carrier phase.

The said excipient described herein can be selected from surfactants, carrier oils, emulsion stabilizers, crosslinkers, solvents, pH adjusting agents, or a mixture thereof.

Surfactants can be selected from polyoxyethylene sorbate, Tween80™, Tween60™, Tween20™, sunflower lecithin, soy lecithin, glycerol, propylene glycol, PEG₂₀₀, PEG₄₀₀, PEG₁₀₀₀, sorbitan monooleate, Span80™, Span60™, Span40™, Triton X™, polyterpene-based surfactants, siloxane-based surfactants, e.g. all Silwet™ group products, preferably Silwet™ L-77, cardanol-based surfactants, concentrated vegetable oil-based surfactants, glycerol monostearate, or binary or ternary combinations thereof.

In a preferred embodiment of the invention, a surfactant in the range of 5-15 vol % is used.

The carrier oil can be selected from neem oil (azadirachta indica), corn oil, coconut oil, medium-chain triglycerides (MCT), palm oil, sunflower oil, cottonseed oil, canola oil, pine oil, or a binary or ternary combination thereof.

In a preferred embodiment of the invention, a carrier oil in the range of 0-25 vol % is used.

The emulsion stabilizer can be selected from carboxymethyl cellulose, hydroxypropyl cellulose, xanthan gum, Arabic gum, starch, pectin, whey protein, and soy protein, or binary or ternary combinations thereof.

In a preferred embodiment of the invention, an emulsion stabilizer in the range of 0-20 vol % is used.

As a crosslinker, sodium tripolyphosphate (TPP) is used.

In a preferred embodiment of the invention, a crosslinker in the range of 0-20 vol % is used.

In one aspect, the invention relates to formulations comprising thymol and at least one other essential oil active ingredient, and at least one polymer-based carrier phase as an excipient, characterized in that:
the other essential oil/essential oil active ingredient is selected from carvacrol, oregano oil, oregano oil containing 80-95 vol % of thymol and carvacrol, geraniol, cinnamaldehyde, eugenol, clove oil, clove oil containing 70-85 vol %. of eugenol, linalool, limonene, cuminaldehyde, L-carvone, citral, thymoquinone, basil oil, lavender oil, lemon oil, orange oil, grapefruit oil, bergamot oil, cumin oil, rose oil, cinnamon oil, mint oil, or combinations of two, three or four of these agents,
the polymer-based carrier is selected from chitosan, alginate, gelatin, dextran, carboxymethyl cellulose, hydroxypropyl cellulose, xanthan gum, Arabic gum, starch, pectin, whey protein, soy protein, and
the formulation comprises a surfactant selected from polyoxyethylene sorbate, Tween80™, Tween60™, Tween20™, sunflower lecithin, soy lecithin, glycerol, propylene glycol, PEG₂₀₀, PEG₄₀₀, PEG₁₀₀₀, sorbitan monooleate, Span80™, Span60™, Span40™, Triton X™, polyterpene-based surfactants, siloxane-based surfactants, cardanol-based surfactants, concentrated vegetable oil-based surfactants, glycerol monostearate, or binary or ternary combinations thereof.

In one embodiment of the invention, the formulations according to the invention may be in the form of an oil-water emulsion (WO) or a capsule suspension (CS).

In a further aspect, the invention relates to a method for preparing the compositions according to the invention, said method (method I) comprises the steps of:
I. mixing at least one essential oil/essential oil active ingredient with a carrier oil, a surfactant, or a surfactant mixture to obtain an oil phase,
II. mixing a polymer-based carrier solution and a surfactant,
III. mixing the solution obtained in the step I and the solution obtained in the step II, and
IV. adding a crosslinker solution dropwise into the solution obtained in the step III.

In one embodiment of the invention, in methods where the step IV is not applied, the mixture obtained in the step III is processed in devices such as an ultrasonicator, a high shear mixer (Ultra-Turrax), a spinning disk reactor, a high-pressure homogenizer, a microfluidic encapsulation device, a stainless-steel membrane emulsification device, a Shirasu Porous Glass Membrane Emulsification Device, etc. to ensure emulsion stability.

In a preferred embodiment of the invention, the crosslinker may be prepared in a solution, wherein said solution may comprise the crosslinker at a concentration of 0.08-0.5 vol %, preferably at a concentration of 0.1-0.3 vol %.

In a preferred embodiment of the invention, the polymer-based phase may be used as a solution in the presence of a solvent. The said polymer-based phase solution may comprise the polymer-based phase at a concentration in the range of 0.5-5 vol %, preferably at a concentration in the range of 0.8-3 vol %.

The solutions described within the scope of the invention can be prepared with organic or inorganic solvents known to the person skilled in the art. Examples of organic solvents include ethanol, methanol, dichloromethane, ethyl acetate, diethyl ether, etc. Examples of inorganic solvents include water, aqueous acid solutions of various concentrations, e.g. 1 vol % acetic acid solution, aqueous base solutions of various concentrations.

In a further aspect, the invention relates to compositions obtainable by a method according to the method I.

In another aspect, the invention relates to the use of the compositions according to the invention in agriculture as bactericides, fungicides, acaricides, and virucides before harvesting, preferably in the fight against pests that cause problems under greenhouse conditions.

In another aspect, the invention relates to the use of the compositions according to the invention as a protective agent to increase the shelf life of fruits and vegetables.

In yet another aspect, the invention relates to the use of the compositions according to the invention after harvesting to destroy microorganisms found in fruits and vegetables and carried from the agricultural field.

In yet another aspect, the invention relates to the use of the compositions according to the invention in the fight against pests including Aspergillus niger, Penicillium digitatum, Botrytis cinerea, Xanthomonas juglandis, Xanthomonas phaseoli, Clavibacter michiganensis, Fusarium culmorum, Rhizoctonia solani, Sclerotinia sclerotiorium, Ascohyta rabiei.

In the embodiments described above, the compositions according to the invention may be administered by dipping or spraying, or by any other technique available in the known art.

### EXAMPLES

### Example 1: Formulation 1, and Method of Preparation Therefor

Oil microcapsules are typically formed by an emulsion encapsulation technique. The required materials include a chitosan solution at a concentration range of 0.1-3 vol % dissolved in a 1-2 vol % weak acid solution, a sodium tripolyphosphate (TPP) aqueous solution at a concentration range of 0.083-0.5 vol %, a thymol-enriched oregano oil (origanum vulgare) containing a total of 80-95 vol % thymol and carvacrol, and at least one surfactant. As the surfactant, Tween80, Tween60, Tween20, sunflower lecithin, soy lecithin, glycerol, propylene glycol, PEG200, PEG400, PEG1000, Span80, Span60, Span40, Triton X. Polymerpene-based surfactants, Siloxane-based surfactants, e.g. all SilwetT group products, preferably Silwet™ L-77. concentrated vegetable oil-based surfactants, cardanol-based surfactants, or glycerol monostearate may be used in the range of 5-15 vol %. In addition, as a carrier oil, neem oil (azadirachta indica), corn oil, coconut oil, medium-chain triglycerides (MCT) may be used in the range of 0-25 vol %, and as an emulsion stabilizer, carboxymethyl cellulose, hydroxypropyl cellulose, xanthan gum, Arabic gum, starch, pectin, whey protein, and soy protein solutions may be used in the range of 0-20 vol %. The total chitosan volume can be adjusted in the range of 40-85 vol %, the total active oil volume in the range of 10-50 vol %, and the crosslinker volume in the range of 0-20 vol %. This type of formulation is called Capsule Suspension (CS).

### Formulation 1 (F1):

24 ml of an enriched oregano oil containing 90 vol % of thymol and carvacrol (at equal volume) is mixed with 56 ml of corn oil via a magnetic stirrer, and 1.4 ml of sunflower lecithin, and 10 ml of Tween80 are added. In a separate container, Tween80 is added at a concentration of 10 vol % to 100 ml of 1 vol % chitosan dissolved in a 1 vol % acetic acid solution. After Tween80 is dissolved, the oil mixture is added to the chitosan solution, and stirred for 1 hour. Thereafter, 30 ml of a TPP solution at a concentration of 0.2 vol % is added dropwise to the chitosan-oil mixture during a 5-min ultrasonication operation. Then, it is stirred for an additional 1 hour at 700 rpm, upon which the process is completed.

### Example 2: Formulation 2, and Method of Preparation Therefor

This formulation is prepared in a similar manner to Formulation 1, except that geraniol is used instead of thymol and carvacrol.

### Formulation 2 (F2):

20.5 ml of a geraniol solution (99 vol % of geraniol in the solution) containing 2.5 vol % of sunflower lecithin is stirred via a magnetic stirrer and added to 15 ml of a 0.16 vol % Sodium Tripolyphosphate (TPP) solution. Then 20 vol % of Tween80 added into the final mix of 15 ml TPP. In a separate container, 3 ml of Tween80 is added to 50 ml of 1 vol % chitosan dissolved in a 1 vol % lactic acid solution. After Tween80 is dissolved, the Geraniol-TPP mixture is added to the chitosan solution, and stirred for 2 hours.

### Example 3: Formulation 3, and Method of Preparation Therefor

This formulation is prepared in a similar manner to Formulation 1, except that cinnamaldehyde is used instead of thymol and carvacrol.

### Formulation 3 (F3):

20.5 ml of a cinnamaldehyde containing 2.5 vol % of sunflower lecithin is stirred via a magnetic stirrer and added to 15 ml of a 0.16 vol % Sodium Tripolyphosphate (TPP) solution Then 20 vol % of Tween80 added into the final mix of 15 ml TPP. In a separate container, 3 ml of Tween80 is added to 50 ml of 1 vol % chitosan dissolved in a 1 vol % lactic acid solution. After Tween80 is dissolved, the Cinnamaldehyde-TPP mixture is added to the chitosan solution, and stirred for 2 hours.

### Example 4: Formulation 4, and Method of Preparation Therefor

This formulation is prepared in a similar manner to Formulation 1, except that a clove oil (syzygium aromaticum) containing 70-90 vol % of eugenol is used instead of thymol and carvacrol.

### Formulation 4 (F4):

6.25 ml of clove oil is mixed with 6.25 ml of corn oil via a magnetic stirrer, and 2 ml of Tween80, and 0.7 ml of sunflower lecithin are added. In a separate container, 3 ml of Tween80 is added to 50 ml of 1 vol % chitosan dissolved in a 1 vol % lactic acid solution. After Tween80 is dissolved, the oil mixture is added to the chitosan solution, and stirred for 2 hours.

### Example 5: Formulation 5, and Method of Preparation Therefor

This formulation is prepared in a similar manner to Formulation 1, except that thymol, eugenol, and geraniol are used instead of thymol and carvacrol.

### Formulation 5 (F5):

10 g of Thymol is mixed with 10 ml of Geraniol and 6.66 ml of clove oil, and then 0.3 ml of sunflower lecithin is added; and, by a magnetic stirrer, this mixture is added to 15 ml of a 0.16 vol % Sodium Tripolyphosphate (TPP) solution. Then 3 ml of Tween80 added into the final mix of 15 ml TPP. In a separate container, 7 ml of Tween80 is added to 50 ml of 1 vol % chitosan dissolved in a 1 vol % lactic acid solution. After Tween80 is dissolved, the Oil-TPP mixture is added to the chitosan solution, and stirred for 2 hours.

### Example 6: Formulation 6, and Method of Preparation Therefor

This formulation is prepared in a similar manner to Formulation 1, except that thymol, carvacrol, and geraniol are used instead of thymol and carvacrol.

### Formulation 6 (F6):

5 g of thymol, 7 ml of oregano oil, 7.2 ml of geraniol, and 0.2 ml of sunflower lecithin are mixed; then, by a magnetic stirrer, this mixture is added to 15 ml of a 0.16 vol % Sodium Tripolyphosphate (TPP) solution. 3 ml of Tween80 added into the final mix of 15 ml TPP. In a separate container, 5 ml of Tween80 is added to 50 ml of 1 vol % chitosan dissolved in a 1 vol % lactic acid solution. After Tween80 is dissolved, the Oil-TPP mixture is added to the chitosan solution, and stirred for 2 hours.

### Example 7: Formulation 7, and Method of Preparation Therefor

This formulation is prepared in a similar manner to Formulation 1, except that cinnamaldehyde and geraniol are used instead of thymol and carvacrol.

### Formulation 7 (F7):

10 g of cinnamaldehyde, and 10 ml of geraniol are mixed with 0.5 ml of sunflower lecithin via a magnetic stirrer, and added to 15 ml of a 0.16 vol % Sodium Tripolyphosphate (TPP) solution Then 2 ml of Tween80 added into the final mix of 15 ml TPP. In a separate container, 3 ml of Tween80 is added to 50 ml of 1 vol % chitosan dissolved in a 1 vol % lactic acid solution. After Tween80 is dissolved, the Oil-TPP mixture is added to the chitosan solution, and stirred for 2 hours.

### Example 8: Formulation 8, and Method of Preparation Therefor

This formulation is prepared in a similar manner to Formulation 1, except that thymol, carvacrol, cinnamaldehyde, and geraniol are used instead of thymol and carvacrol.

### Formulation 8 (F8):

5 g of cinnamaldehyde, 5 ml of geraniol, and 11 ml of a thymol-enriched oregano oil containing 90 vol % of thymol and carvacrol (An equal volume of enriched oregano oil is produced, containing a total of 94.7% Thymol-carvacrol combination. (Enrichment is done by adding an equivalent volume of thymol to oregano oil containing 90% carvacrol.)) are mixed with 0.7 ml of sunflower lecithin via a magnetic stirrer and added to 15 ml of a 0.16 vol % Sodium Tripolyphosphate (TPP) solution Then 3 ml of Tween80 added into the final mix of 15 ml TPP. In a separate container, 7 ml of Tween80 is added to 50 ml of 1 vol % chitosan dissolved in a 1 vol % lactic acid solution. After Tween80 is dissolved, the Oil-TPP mixture is added to the chitosan solution and stirred for 2 hours.

### Example 9: Formulation 9, and Method of Preparation Therefor

This formulation is prepared in a similar manner to Formulation 1, except that thymol, carvacrol, and cinnamaldehyde are used instead of thymol and carvacrol.

### Formulation 9 (F9):

9 g of thymol, 10 ml of oregano oil, and 5 ml of cinnamaldehyde are mixed with 0.7 ml of sunflower lecithin via a magnetic stirrer, and added to 15 ml of a 0.16 vol % Sodium Tripolyphosphate (TPP) solution. Then3 ml of Tween80 added into the final mix of 15 ml TPP. In a separate container, 7 ml of Tween80 is added to 50 ml of 1 vol % chitosan dissolved in a 1 vol % lactic acid solution. After Tween 80 is dissolved, the Oil-TPP mixture is added to the chitosan solution, and stirred for 2 hours.

### Example 10: Formulation 10, and Method of Preparation Therefor

This formulation is prepared in a similar manner to Formulation 1, except that thymol, carvacrol, eugenol, and geraniol are used instead of thymol and carvacrol.

### Formulation 10 (F10):

5 g of thymol, 6 ml of oregano oil, 6.7 ml of clove oil, and 5 ml of geraniol are mixed with 0.7 ml of sunflower lecithin via a magnetic stirrer and added to 15 ml of a 0.16 vol % Sodium Tripolyphosphate (TPP) solution. Then 7 ml of Tween80 added into the final mix of 15 ml TPP. In a separate container, 3 ml of Tween80 is added to 50 ml of 1 vol % chitosan dissolved in a 1 vol % lactic acid solution. After Tween80 is dissolved, the Oil-TPP mixture is added to the chitosan solution and stirred for 2 hours.

### Example 11: DLS Particle Size Analysis and Zeta Potential

The size and polydispersity of the resulting microcapsules are important parameters for release kinetics. The lower the polydispersity, the more regular the release of active ingredients into a medium. For emulsions, DLS measurements are one of the major quality control methods for stability. The smaller the size of oil particles in an emulsion and the lower a Polydispersity Index, the longer the stability of the emulsion lasts.

Zeta Potential measurements constitute an important quality control method for the success of encapsulation. The presence of a high value of Zeta Potential indicates the presence of a high suspension stability of microcapsules.

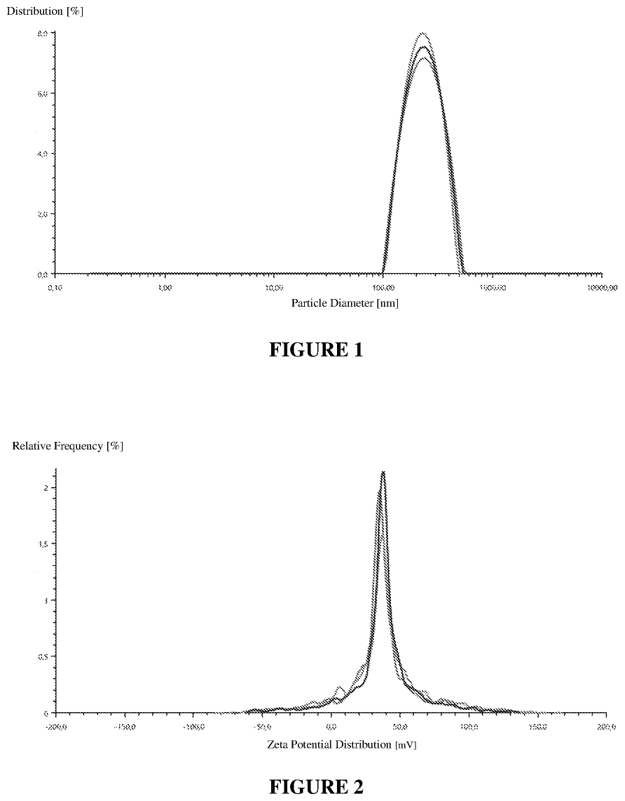

Dynamic Light Scattering (DLS) and Zeta Potential measurements for Formulation 1 are as shown in FIGS. 1 and 2. In three different analyses, the hydrodynamic diameter of the microcapsules was found to be 257.2 nm, 259.1 nm, and 254.2 nm, by taking 60 measurements in each of the analyses. Polydispersity Index was measured as 13.7 vol %, 10.2 vol %, and 11.1 vol %. The results obtained from Zeta Potential measurements also demonstrate that the chitosan polymer encapsulates the oil content. Again in three different analyses, the Zeta Potentials, which were calculated by the Smoluchowski equation, were found to be 22.4 mV. 22.7 mV, and 22.8 mV, respectively, by taking 1000 measurements in each of the analyses.

### Example 12: Determination of Minimum Inhibitory Concentrations (MIC) of F1-F10 Formulations

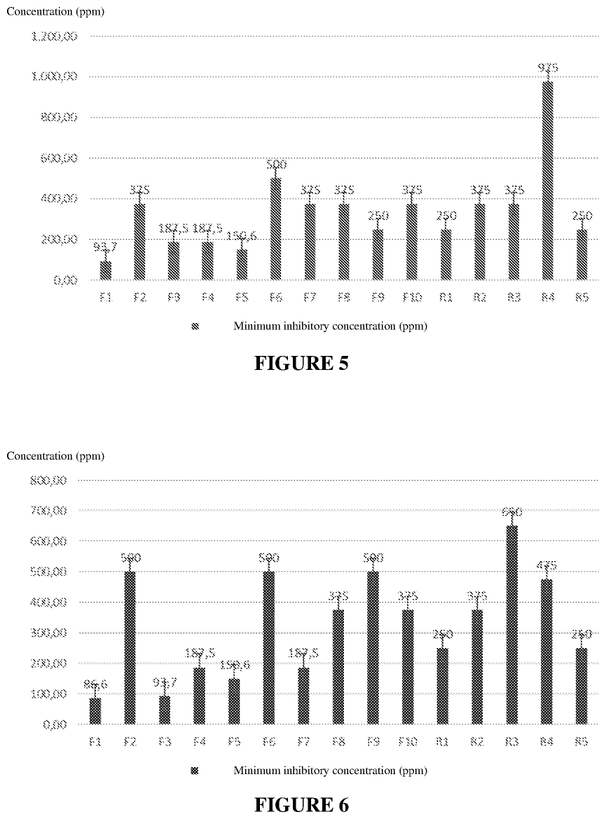

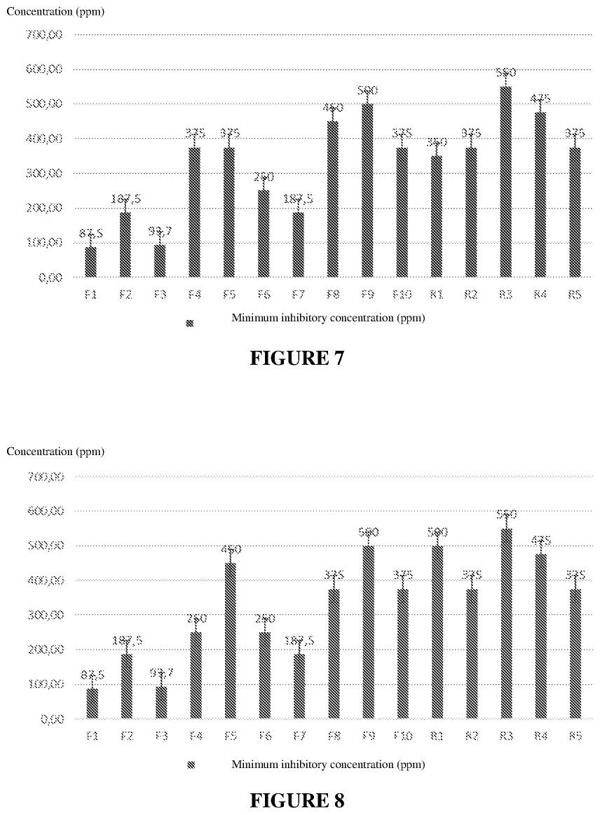

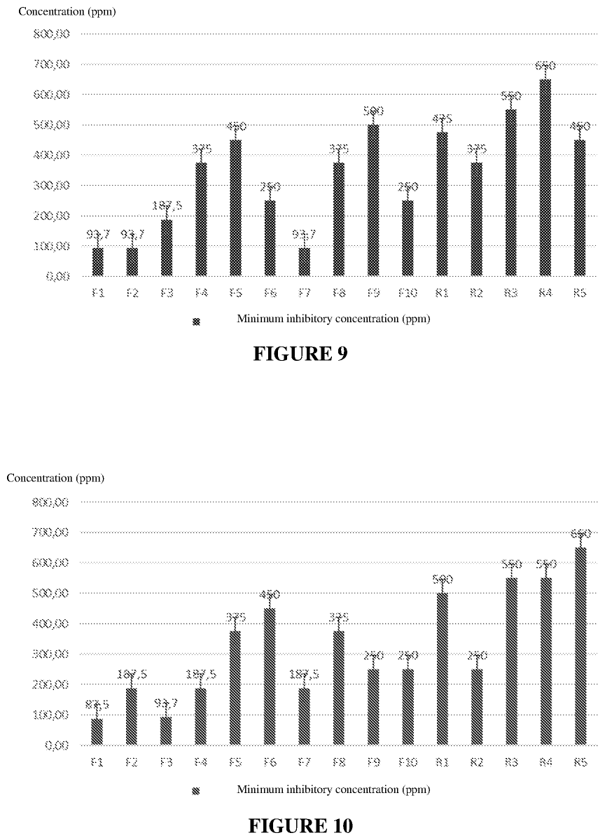

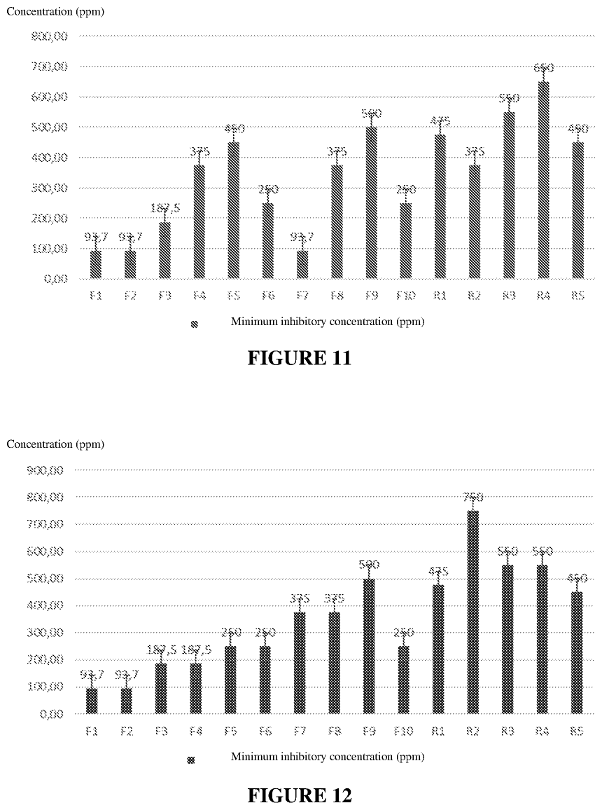

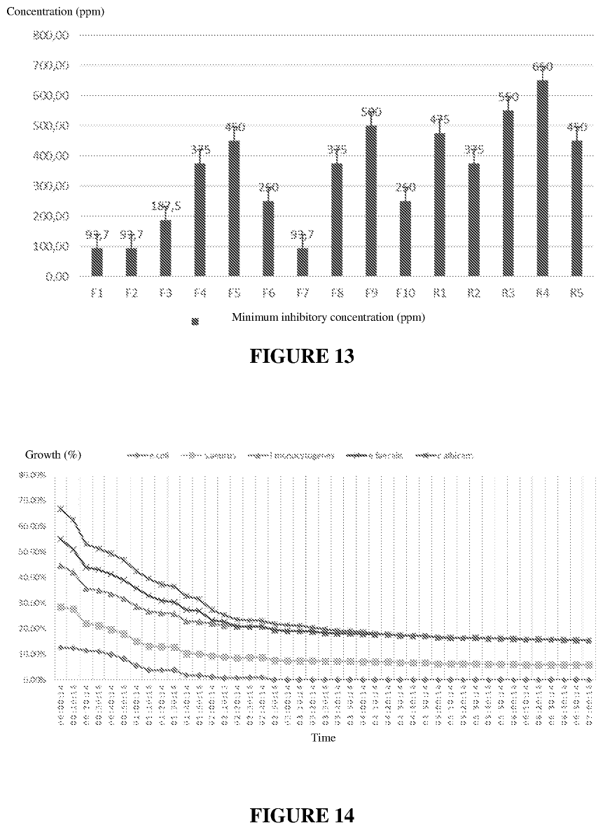

In order to measure the efficacy of formulations on target microorganisms, the minimum inhibitory concentration (MIC) values should be determined. In order to determine the MIC values of the prepared formulations in vitro, the doses of the active ingredients of the formulation are adjusted in the range of 1000-23 ppm (doses are respectively 975-750-650-500-450-375-250-187.5-93.7-87.5-65.7-23 ppm), and the formulations are tested against the target microorganism at 12 different doses on a 96 microplate by a serial dilution method (Starting from different main doses, 12 different sub-doses were studied with serial dilution.). The experiment was optimized with a final volume of 200 μl of the a active ingredient plus a medium in one well. Malt extract agar solid medium is used as the medium for mold microorganisms. After said medium is added to the wells having different concentrations of an active ingredient, it is allowed to solidify. After the media solidifies, 10 μl of a mold suspension of 0.5 McFarland turbidity is added to the wells. In each of the prepared plates, the “Imazalil+medium+mold” and the “Medium+mold” as positive controls, and the “medium” alone as a negative control are included as a control group. After incubating the plates at 28° C. for 7 days, the lowest dose at which a mold growth is observed is determined as the MIC value. The antimicrobial minimum inhibitory concentrations of active ingredients and formulations against different microorganisms are shown in FIG. 4, FIG. 5, FIG. 6, FIG. 7, FIG. 8, FIG. 9, FIG. 10, FIG. 11, FIG. 12, and FIG. 13.

According to these results, the most effective formulations against Aspergillus niger are Formulation 1 and Formulation 3. The most effective formulations against Penicillium digitatum are Formulation 1, Formulation 3, Formulation 4, and Formulation 5. The most effective formulations against Botrytis cinerea are Formulation 1, Formulation 3, Formulation 4, Formulation 5, and Formulation 7.

### Example 13: Efficacy of F1-F10 Formulations Against ATCC PTA-5935 Murine Norovirus

As can be seen in the table (Table 1) below, all of the F1-F10 Formulations at different concentrations have reduced the viral titer of Murine Norovirus, a member of the RNA virus family, by 4 logs within a 5-minute contact time, and thus, the virucidal efficacy of said formulations was found to be positive.

TABLE 1
Virucidal efficacy of the formulations according to the invention
against Murine Norovirus within a 5-minute contact time

| | Experiment | Effective | Contact | Reduction in |
|---|---|---|---|---|
| | Method | Dose | Time | Viral Titer (log) |
| F1 | TS EN 14476 | 100 ppm | 5 min | >4 |
| F2 | | 200 ppm | | |
| F3 | | 100 ppm | | |
| F4 | | 150 ppm | | |
| F5 | | 150 ppm | | |
| F6 | | 200 ppm | | |
| F7 | | 200 ppm | | |
| F8 | | 200 ppm | | |
| F9 | | 150 ppm | | |
| F10 | | 200 ppm | | |

### Example 14: Determination of Killing Kinetics Against Bacterial and Fungal Microorganisms

Killing kinetics assays are a type of in vitro assay that is carried out in order to observe how long it takes for active ingredients and formulations to act against bacterial and fungal microorganisms. In this assay, formulations and media containing a specific concentration of active ingredients are placed in 96-well plates at a 1:1 ratio with a total volume of 200 μl. LB Agar for bacteria, and PDB Agar for fungi are used as media. Then, 20 μl of a microorganism suspension of 0.5 McFarland turbidity is added to the wells, and measurements are taken in a multi-plate reader at a 600-nanometer wavelength for 24 hours at certain time intervals. Kanamycin or Imazalil plus Individual Microorganisms are used as a positive control for bacteria or fungi, respectively, and “Formulation+Medium” is used as a negative control. The assays were carried out in triplets. For calculating the growth percentages, the following formula was used:

$$Growth Percentage \frac{ODFinal - ODSampleControl}{ODMicroorganism} \times 100$$

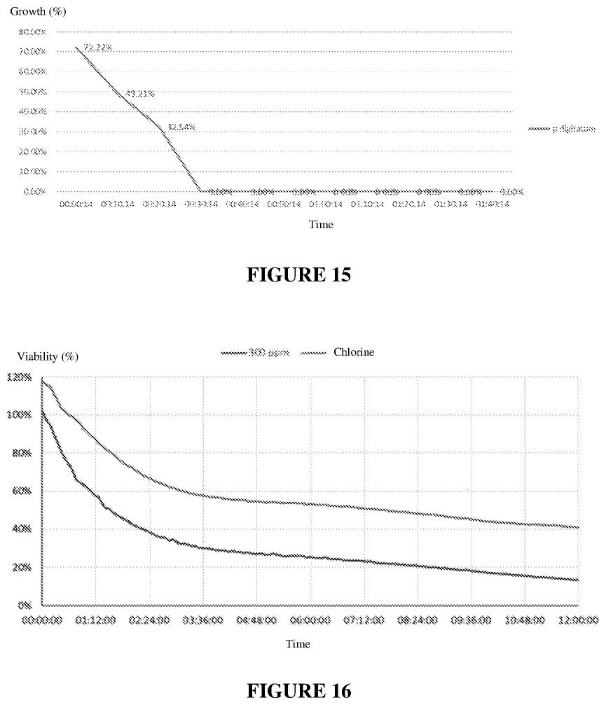

### (OD: Optical Density)

wherein the growth rates at time t were calculated. These values are then taken, and the results are analyzed in a Growth Rate/Time graph. These assays were carried out against E. Coli, S. Auerus, L. Monocytogenes, E. Faecalis, Candida Albicans, and Penicillium Digitatum with Formulation 1 at a concentration of 1500 ppm (FIG. 14, FIG. 15).

It has been observed that the emulsion and encapsulation formulations constitute a significant method for increasing the activity of most of the active ingredients, and at the same time, for maintaining their stability. The synergistic use of active ingredients resulted in a more effective antimicrobial activity in relation to the mechanisms of action of said active ingredients. These formulations have proven to be effective against agricultural pests and have a high activity against food pathogens. On the other hand, the residue problem caused by the use of chemical pesticides has been avoided thanks to the rapidly scalable emulsion and encapsulation formulations which were developed by using a variety of natural active ingredients.

In another study, a cell viability suppression study using a Listeria monocytogenes culture taken from contaminated vegetable groups as microorganisms, the highest reduction in microorganism viability was seen with a 300 ppm dose of Formulation 1. The comparison was made with chlorine used for disinfection of fruits and vegetables (FIG. 16).

### Analysis of Antifungal Activity of Dry Capsules at Different pHs

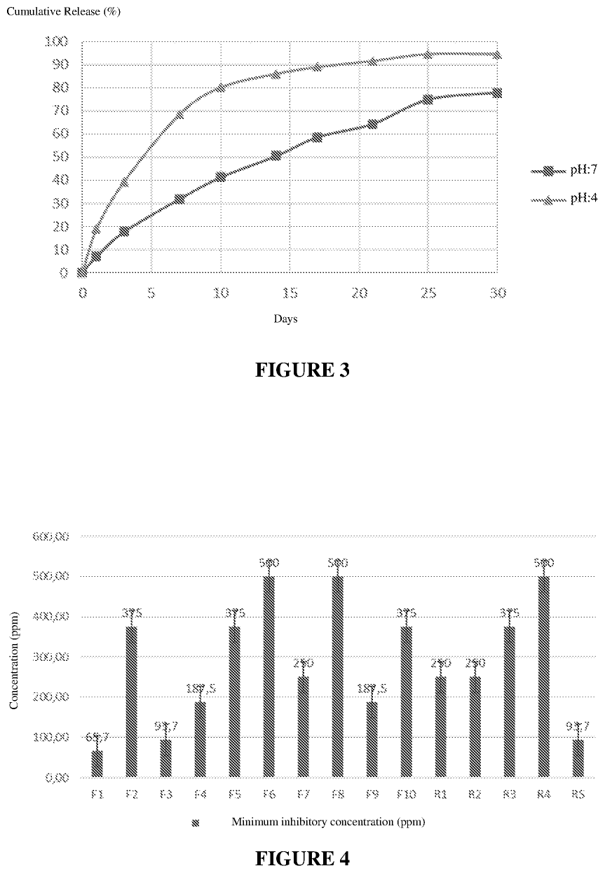

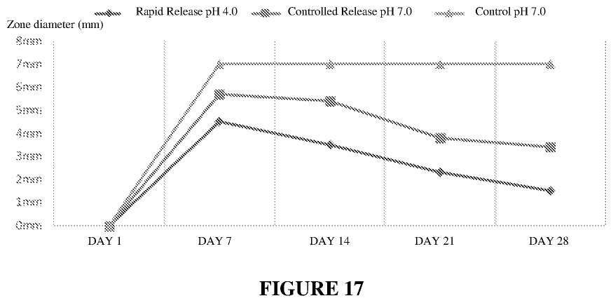

The dried capsules were added to 5 ml of a PDB medium in glass tubes at a concentration of 0.2 mg/ml, and then, a Penicillium digitatum spore suspension was added to each tube at a concentration of 10⁷ spores/ml. The medium pH in one of the groups was adjusted to 4, while the pH in the other group was set at 7. As a control group, a group involving the same amount of spores at pH 7 with no capsules added was used. In this way, the effect of different release kinetics profiles observed at different pHs on the survival of fungal cells was investigated (FIG. 3). Every 7 days, 100 μl samples from the test groups were collected in glass tubes, and a spot inoculation was performed on PDA media. The groups inoculated on PDA were incubated for 1 week, upon which growth diameters were measured. Accordingly, while the survival of fungal cells in the control group which included no capsules was not affected, the viability of fungal cells was significantly affected in the groups where both a controlled release and a “burst release” were seen at different pHs (FIG. 17). The “burst release” effect, i.e. the rapid release effect which was also observed in the release kinetics studies, reduced the growth activities of fungal cells faster in capsules in a medium at pH 4 than in those in a medium at pH 7.

### Example 15: In Vitro Trials of F1 Formulation Against Botrytis cinerea

The in vitro activity assays of Formulation 1 against Botrytis cinerea were carried out by an agricultural research institute in Spain. Different varieties of grapes which had been cultivated by different production techniques were collected from the Basque region of Spain, and stored at 4° C. until use. Before the assays, the fruits were sterilized by being immersed in each of a 70 vol % ethanol solution, a 0.5 vol % sodium hypochlorite solution, and a 0.2 vol % Tween20 solution, and a distilled water solution for 10 minutes, and allowed to dry.

As assay groups, Formulation 1 solutions prepared at concentrations of 0.3 vol %, 0.15 vol %, 0.075 vol %, and 0.0375 vol %, as well as Timorex Gold solutions at concentrations of 0.4 vol %, 0.2 vol %. 0.1 vol %, and 0.05 vol % were prepared.

Fruits in each group were immersed in products and in a dilution combination for 15 minutes. The fruits were then placed on plastic grids in plastic containers for drying purposes, and stored overnight at 4° C. until being inoculated with Botrytis cinerea spores.

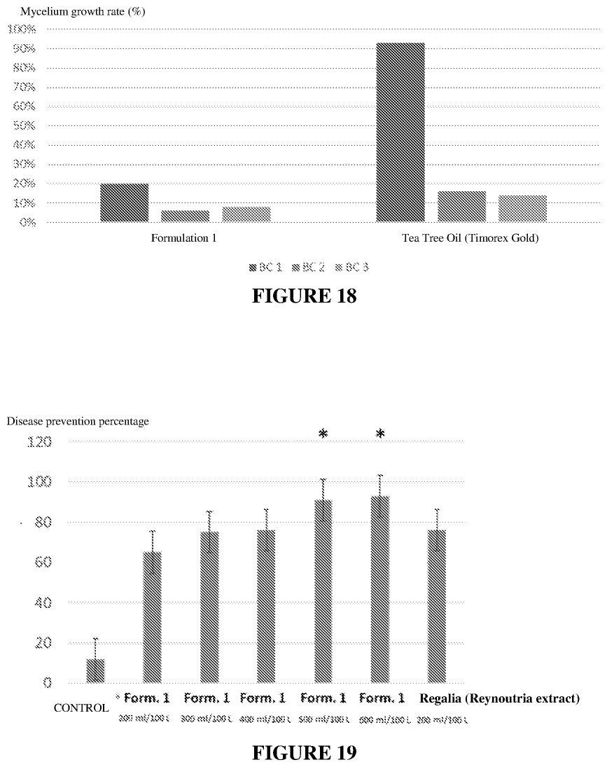

Botrytis cinerea isolate CECT20518 from the Spanish Culture Collection was used for inoculation. The isolate was grown on PDA medium until sporulation was observed, and then the spores in the medium were adjusted to a concentration of 100 CFU/ml. The fruits in each group were inoculated with 100 ul of a spore suspension by inserting an insulin needle to a depth of 2 mm, and the grapes were stored at 20° C. and 100 vol % relative humidity. The results were calculated according to mycelium (mycel vol %) and sporulation (sporul vol %) rates after 15 days (FIG. 18).

According to the results, a lower amount of mycelium formation was observed in the group treated with Formulation 1 against Hondarrabi zuri, Mazuelo and Viura grape varieties compared to that in the control groups. A lower amount of mycelium growth was observed in the conventionally produced grapes compared to that in the organically produced grapes (Table 2).

TABLE 2
Effects of Formulation 1 solutions and Timorex Gold solutions on mycelium and sporulation

| | | CONTROL | | FORMULATION 1 | | TIMOREX GOLD ™ | |
|---|---|---|---|---|---|---|---|
| | | MYCEL | SPORUL | MYCEL | SPORUL | MYCEL | SPORUL |
| | | vol % | vol % | vol % | vol % | vol % | vol % |
| Production | Organic (org) | 49.39 | 44.4 | 40.1 | 34.82 | 49.17 | 43.94 |
| System | Conventional (con) | 39.50 | 30.9 | 28.9 | 19.40 | 36.13 | 24.70 |
| Grape | Graciano | 24.67 | 49.9 | 25.8 | 39.76 | 29.67 | 34.90 |
| Variety | H. Zuri | 62.50 | 3.12 | 19.8 | 12.04 | 21.61 | 8.60 |
| | Mazuelo | 22.00 | 0 | 15.3 | 0 | 20.00 | 0 |
| | Tempranillo | 51.43 | 46.3 | 48.7 | 31.88 | 56.14 | 33.27 |
| | Viura | 57.25 | 31.8 | 48.1 | 31.63 | 57.75 | 10.62 |
| Dilution | 1 | — | — | 27.2 | 22.65 | 36.33 | 21.48 |
| (ppm)* | 2 | — | — | 35.9 | 27.46 | 40.00 | 26.84 |
| | 3 | — | — | 40.40 | 30.46 | 46.00 | 31.84 |
| | 4 | — | — | 42.2 | 31.65 | 48.33 | 31.48 |

*For Formulation 1: 1 = 3000, 2 = 1500, 3 = 750, 4 = 375; For Timorex: 1 = 4000, 2 = 2000, 3 = 1000, 4 = 500

The activity of Formulation 1 against Botrytis cinerea was observed in 24-well plate assays. For this purpose, the PDA medium and the formulations were mixed at concentrations of 0-3000 ppm, and their efficacies against 3 different Botrytis isolates were analyzed. Inoculations were made by adding 100 μl of spore suspensions at a concentration of 100 CFU/ml to the wells, and the plates were incubated at 28° C. for 1 week. The assays were repeated 3 times, and the growth rates were calculated in reference to the control groups.

Formulation 1 showed a higher efficacy than Timorex within the range of dilutions of 3000 and 250 ppm. It should be noted that Formulation 1 was administered to fruits at a lower dose than Timorex (Table 3).

TABLE 3
Effect of Formulation 1 at different doses on mycelium
growth of Botrytis cinerea (OD: 570 nm)

| | | Formulation 1 | Timorex Gold |
|---|---|---|---|
| Dose (ppm) | 0 | 0.36 | 0.33 |
| | 62.5 | 0.33 | 0.55 |
| | 93.75 | 0.35 | 0.44 |
| | 125 | 0.36 | 0.44 |
| | 187.5 | 0.25 | 0.33 |
| | 250 | 0.18 | 0.33 |
| | 375 | 0.12 | 0.33 |
| | 500 | 0 | 0.44 |
| | 750 | 0 | 0.44 |
| | 1000 | 0 | 0.33 |
| | 2000 | 0 | 0.25 |
| | 3000 | 0 | 0.11 |

### Example 16: Field Experiments of F1 Formulation

Field experiments for Formulation 1 were carried out by an accredited third-party organization in Manisa, Turkey, against the powdery mildew disease in grapes. The experiment was designed by the method of randomized blocks, and a number of experimental groups, including a control group, 4 different doses of Formulation 1, and the recommended dose of Regalia, a commercially available biopesticide, was formed with 6 characters and 4 repetitions, and the inhibition rates against the powdery mildew disease were calculated (Table 4).

### Experimental Design

TABLE 4
The randomized block experimental design of the
field experiment for the efficacy of Formulation
1 against powdery mildew (Erysiphae necator)

| | | | |
|---|---|---|---|
| 106 (6) | 206 (5) | 306 (4) | 406 (2) |
| 105 (5) | 205 (2) | 305 (6) | 405 (4) |
| 104 (4) | 204 (1) | 304 (3) | 404 (2) |
| 103 (3) | 203 (4) | 303 (5) | 403 (6) |
| 102 (2) | 202 (6) | 302 (1) | 402 (3) |
| 101 (1) | 201 (2) | 301 (2) | 401 (5) |

1- Formulation 1-300 ml/100 L water
2- Formulation 1-400 ml/100 L water
3- Formulation 1-500 ml/100 L water
4- Formulation 1-600 ml/100 L

The experiments were started on Nov. 5, 2020, and a total of 5 treatments were performed. Weather conditions were recorded as Temperature: 22° C., Humidity: 38 vol %, Wind speed: 1.4 m/s, and treatments were performed with a 25 L HYUNDAI FST-768 knapsack sprayer. The experiment was designed with 6 characters and 4 repetitions. Each plot had 6 vines, and an average of 1.5 liters of water was used for each plot. The age of the vines was recorded as 10 years. The vine height was recorded as 1.70-1.90 meters, and the cultivation method was recorded as the “cordon de Royat” system. The application phenology was determined as the end of flowering. According to the results of counts made at the end of the experiment, the disease rate in the control group was 35 vol %, and the most successful groups in providing protection against the disease were 500 and 600 ml/100L water doses of Formulation 1, as well as Regalia. The 600 ml/100L dose of Formulation 1 was found to be more effective than Regalia (FIG. 19).

Testing of Formulation 1 in the Same Program with Synthetic Fungicides in the Fight Against Powdery Mildew (Erysiphae necator)

In another experiment, the preventive and inhibitory effect of Formulation 1 in combination with a synthetic fungicide treatment program against the powdery mildew was investigated. This experiment was applied with 5 characters and 4 repetitions. The applications were completed in a vineyard in Killik village, Manisa province. In this experiment the treatments were started before flowering, and the experiment was continued until the grapes reached veraison. Treatment programs are shown in Table 5.

TABLE 5
Experiment programs prepared for testing of Formulation 1 in combination with
synthetic fungicides in the fight against Powdery Mildew (Erysiphae necator)

| | | Conventional + | Single window |
|---|---|---|---|
| Grape growth stages | Conventional | Formulation 1 | Formulation 1 |
| Before buds opened | X | X | X |
| Shoot length, 2-3 cm | X | X | X |
| Shoot length, 8-10 cm | X | X | X |
| Shoot length, 25-30 cm | Luna Experience | Luna Experience | Formulation 1 |
| | and Prosper | and Prosper | |
| Flowering period | | | |
| Post flowering | Prosper | Formulation 1 | Formulation 1 |
| Berries pea-sized | Flint | Formulation 1 | Formulation 1 |
| When berries start to get bigger | Bayfidan | Formulation 1 | Formulation 1 |
| Berries in sweetening period | X | X | X |
| Ripening period | X | X | X |

In control plots, the disease rate was determined as 12.5 vol %. The disease control in control plots to which only Formulation 1 was applied was found as 80 vol %. The disease control percentages were 91 vol % and 93.5 vol %, respectively, in the group in which the synthetic fungicide program was applied before flowering and the Formulation 1 after flowering, and in the group in which only synthetic fungicide was administered (FIG. 20). The results of this experiment indicate that Formulation 1 has a significantly preventive and controlling effect against Erysiphae necator, the causal agent of powdery mildew.

Testing of the Biological Efficacy of Formulation 1 Against Botrytis Vine Rot (Botrytis cinerea).

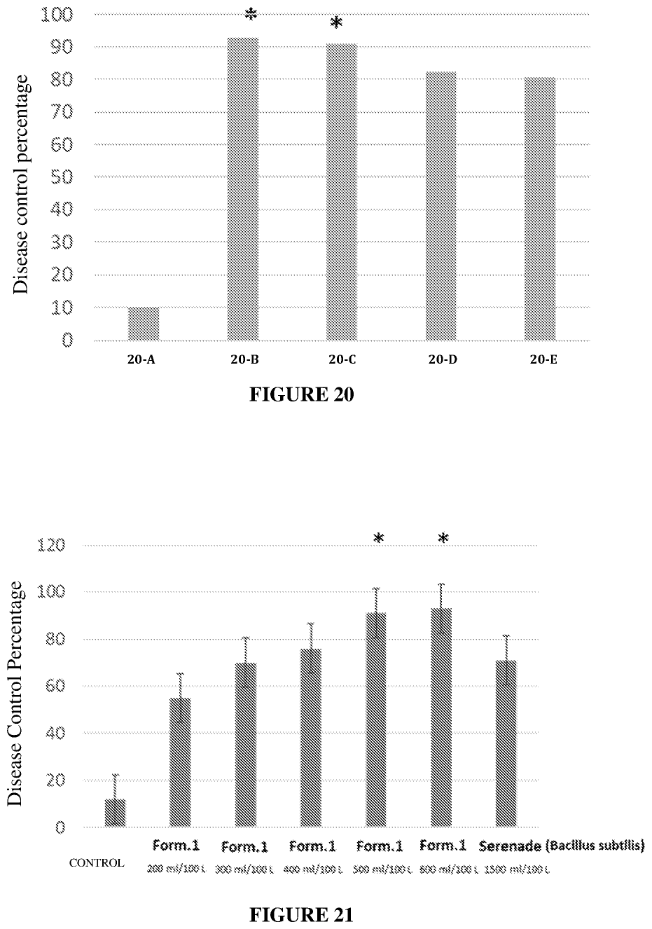

In another study, Formulation 1 was tested for its efficacy against Botrytis cinerea, a pest of vineyard grapes that causes significant commercial losses. In this experiment, the efficacy of Formulation 1 at different concentrations was compared with the efficacy of the currently licensed product Serenade. The disease rate was 40 vol % in control plots. Treatment application interval was determined as 10 days, and a total of 5 applications were made. As a result of the counts of diseased and healthy grape berries made after all sprayings, 500 ml/100 L and 600 ml/100 L doses of Formulation 1 were the best performing experiment groups (FIG. 21). The grape variety was Sultani, and the age of the vineyard was recorded as 11 years. The vine height was recorded as 1.70-1.90 meters, and the cultivation method was recorded as the “cordon de Royat” system. The application phenology was determined as the sweetening and ripening period.

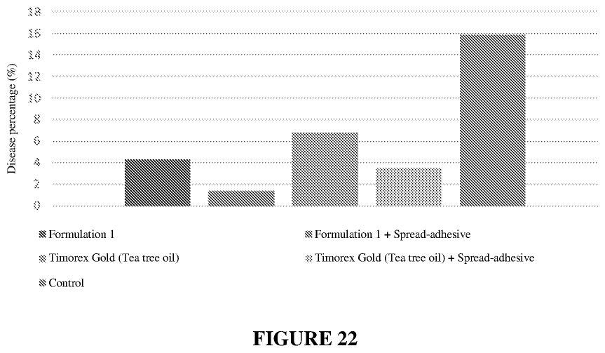

In another experiment, how the contact activity of Formulation 1 was changed when it is used in combination with a spread-adhesive products (polysiloxane), and how its biological activity against Botrytis cinerea was changed when it is used in combination with other vegetable oil-containing products, were investigated. As a result, the disease rate was recorded as 15.9 vol % in the control groups, 4.2 vol % in Formulation 1, 1.6 vol % in Formulation 1 group using the spread-adhesive, 6.4 vol % in the group using “Timorex gold,” and 3.8 vol % in the group using the spread-adhesive (FIG. 22).

As can be appreciated in the light of all these data, the formulations of the present invention comprising thymol and at least one other essential oil active ingredient, as well as at least one polymer-based carrier phase as an excipient, show better efficacy compared to chemical agents such as Regalia and Timorex Gold, which are available in the state of the art.

Regalia™ as used in the present disclosure refers to a fungicide product in the form of a suspension concentrate containing Reynoutria spp. extract.

Timorex Gold™ as used in the present disclosure refers to a fungicide product in the form of an emulsion concentrate containing tea tree oil.

Luna Experience™ as used in the present disclosure refers to a fungicide product in the form of a suspension concentrate containing the active ingredients fluopyram and tebuconazole.

Prosper™ as used in the present disclosure refers to a fungicide product in the form of an emulsion concentrate containing spiroxamine.

Flint™ as used in the present disclosure refers to a fungicide product in the form of water dispersible granules containing trifloxystrobin.

Bayfidan™ as used in the present disclosure refers to a fungicide product in a water-emulsifiable form containing triadimenol.

### MEANINGS OF ABBREVIATIONS IN THE FIGURES

FIG. 1
A=Distribution [%]
B=Particle Diameter [nm]
FIG. 2
C=Relative Frequency
D=Zeta Potential Distribution [Mv]
FIG. 3
E=Cumulative Release
F=Days
FIG. 4
G=Concentration (ppm)
H=Minimum inhibitory concentration (ppm)
FIG. 14
I=Growth (%)
J=Time
K=e.coli
L=s.aeurus
M=l monocytogenes
N=e. faecalis
O=c albicans
FIG. 15
P=p digitatum
FIG. 16
R=Viability (%)
S=Chlorine
FIG. 17
T=Zone diameter (mm)
U=Rapid Release pH 4.0
V=Controlled Release pH 7.0
Y=Control
Z=Day
FIG. 18
A1=Mycelium growth rate (%)
B1=Formulation 1
C1=Tea Tree Oil (Timorex Gold)
FIG. 19
D1=Disease prevention percentage
E1=Form. 1
F1=Regalia (Reynoutria extract)
FIG. 20
G1=Disease control percentage
FIG. 21
H1=Serenade (Bacillus subtilis)
FIG. 22
I1=Disease percentage (%)
J1=Formulation 1+Spread-adhesive
K1=Timorex Gold (Tea tree oil)+Spread-adhesive

1-23. (canceled)

24. The use of a microcapsule composition comprising one or more essential oils and/or essential oil active ingredients and including chitosan, and sodium tripolyphosphate (TPP) as a crosslinker in its wall structure,
(i) in agriculture as a bactericide, a fungicide, an acaricide, or a virucidal agent before harvesting; or
(ii) as a preservative agent to increase the shelf life of fruits and vegetables; or
(iii) after harvesting to destroy microorganisms found in fruits and vegetables and carried from the agricultural field.

25. The use of a microcapsule composition according to claim 24 in the fight against pests that cause problems under greenhouse conditions.

26. The use of a microcapsule composition according to claim 24 in the fight against pests, including Aspergillus niger, Penicillium digitatum, Botrytis cinerea, Xanthomonas juglandis, Xanthomonas phaseoli, Clavibacter michiganensis, Fusarium culmorum, Rhizoctonia solani, Sclerotinia sclerotiorium, Ascohyta rabiei.

27. The use of a microcapsule composition according to claim 24, wherein said microcapsule composition comprises thymol as an essential oil active ingredient.

28. The use of a microcapsule composition according to claim 27, wherein said microcapsule composition further comprises carvacrol, geraniol, cinnamaldehyde, eugenol, linalool, limonene, cuminaldehyde, L-carvone, citral, or thymoquinone as an essential oil active ingredient.

29. The use of a microcapsule composition according to claim 24, wherein said microcapsule composition comprises oregano oil, clove oil, basil oil, lavender oil, lemon oil, orange oil, grapefruit oil, bergamot oil, cumin oil, rose oil, cinnamon oil, or mint oil as an essential oil.

30. The use of a microcapsule composition according to claim 24, wherein as an essential oil said microcapsule composition comprises an oregano oil containing 80-95 vol % thymol and/or carvacrol.

31. The use of a microcapsule composition according to claim 24, wherein said essential oil is a clove oil containing 70-85 vol % of eugenol.

32. The use of a microcapsule composition according to claim 24, wherein said microcapsule composition comprises thymol, eugenol, carvacrol, and cinnamaldehyde as the essential oil active ingredient.

33. The use of a microcapsule composition according to claim 24, wherein said microcapsule composition comprises thymol, eugenol, and geraniol as the essential oil active ingredient.

34. A microcapsule composition comprising one or more essential oils and/or essential oil active ingredients and including chitosan and sodium tripolyphosphate (TPP) as a crosslinker in its wall structure, wherein the chitosan content forming the microcapsule wall is in the range of 40-85 vol % of the total volume of the microcapsule.

35. A microcapsule composition according to claim 34, wherein the microcapsule composition comprises thymol as an essential oil active ingredient.

36. A microcapsule composition according to claim 35, further comprises carvacrol, geraniol, cinnamaldehyde, eugenol, linalool, limonene, cuminaldehyde, L-carvone, citral, or thymoquinone as an essential oil active ingredient.

37. A microcapsule composition according to claim 34, wherein the microcapsule composition comprises oregano oil, clove oil, basil oil, lavender oil, lemon oil, orange oil, grapefruit oil, bergamot oil, cumin oil, rose oil, cinnamon oil, or mint oil as an essential oil.

38. A microcapsule composition according to claim 34, wherein as an essential oil the microcapsule composition comprises an oregano oil containing 80-95 vol % thymol and/or carvacrol.

39. A method for preparing a microcapsule composition according to claim 34, characterized in that:
I. mixing one or more essential oils or essential oil active ingredients with a carrier oil and a surfactant to obtain an oil phase,
II. mixing a polymer-based carrier solution and a surfactant,
III. mixing the solution obtained in the step I and the solution obtained in the step II, and
IV. adding sodium tripolyphosphate (TPP) as a crosslinker solution dropwise into the solution obtained in the step III.

40. A method according to claim 39, characterized in that the crosslinker solution is used at a concentration of 0.08-0.5 vol %.

41. A method according to claim 39, characterized in that the polymer-based phase is used as a solution in the presence of a solvent.

42. A method according to claim 39, characterized in that the polymer-based phase solution is used at a concentration in the range of 0.8-3 vol %.
